(19) United States
(12) Patent Application Publication
(10) Pub. No.: US 2025/0388138 A1
(43) Pub. Date: Dec. 25, 2025

(54) BASE FOR INTERCHANGEABLY CONNECTING AN INFANT CARRIER AND A CHILD CAR SEAT

(71) Applicant: Kylie Mosby, Gilbert, AZ (US)

(72) Inventor: Kylie Mosby, Gilbert, AZ (US)

(21) Appl. No.: 19/244,793

(22) Filed: Jun. 20, 2025

Related U.S. Application Data
(60) Provisional application No. 63/661,709, filed on Jun. 19, 2024.

(51) Int. Cl. B60N 2/28; A47D 13/02; B60N 3/10

(52) U.S. Cl. CPC B60N 2/2827; A47D 13/027; B60N 2/2809; B60N 2/2845; B60N 2/286; B60N 2/2863; B60N 3/101

(57) ABSTRACT

A base for accommodating both an infant carrier and a child car seat includes a rebound portion and a bottom portion. The bottom portion presents a connection portion. In one embodiment, the bottom portion interfaces with a bottom of the infant carrier such that the infant carrier connects to the base in a rear-facing configuration. In one embodiment, the connection portion includes seat receiving sections that are configured to receive carrier legs of the infant carrier or child car seat legs of the child car seat and enable connection between the base and the infant carrier or a child car seat. The base allows connecting the child car seat in a front-facing configuration or a rear-facing configuration depending on the need. The base eliminates the need to install multiple bases by offering compatibility for two different seating products i.e., the infant carrier and child car seat.

### CROSS-REFERENCE TO RELATED APPLICATIONS

The present application claims the benefit of U.S. Provisional Application No. 63/661,709, filed Jun. 19, 2024; all of which is incorporated herein in its entirety and referenced thereto.

### BACKGROUND OF THE INVENTION

### Field of the Invention

The present invention relates to child safety seats, and in particular, relates to a base that allows interchangeably connecting both an infant carrier and a child car seat.

### Description of the Prior Art

Infant carriers and child car seats are commonly used for safeguarding infants and young children during their vehicular travel. The infant carriers are designed to accommodate newborns and infants. The infant carriers typically include a rear-facing configuration to align with the recommended safety guidelines for infants. The child car seats are designed to accommodate older infants and young children, say for children between the age of 2 to 6 years. The child car seats come in various configurations, such as a rear-facing, a forward-facing, and a convertible mode capable of adapting to the child's growth and developmental stages.

Several infant carriers and/or the child car seats have been disclosed in the past. One such example is disclosed in a U.S. Publication No. 2023006857, entitled “Rotatable car seat and base” (“the '857 Publication”). The '857 Publication discloses a car seat consisting of a base and a shell. The base includes a receiving portion and a backing portion. The seat shell includes a seat back and a seat bottom having a lower portion. The seat bottom is convex and interfaces with the receiving portion of the base. The seat shell is rotatable with respect to the base. The seat shell is selectively positionable between a plurality of orientations. The seat shell includes handles configured to independently unlock rotation of the seat shell with respect to the base. The lower portion of the seat shell includes an aperture configured to receive at least a portion of a projection of the base therethrough.

Another example is disclosed in a U.S. Publication No. 20230226957, entitled “Child safety seat rotatably mounted on a base” (“the '957 Publication”). The '957 Publication discloses a child safety seat and base assembly, wherein a base is arranged to be secured with respect to a motor vehicle and a seat is arranged to be removably secured. The assembly includes: a rotary element rotatably mounted to the base; a seat latch on the rotary element that engages the child safety seat to releasably hold the child safety seat to the base and rotary element; a seat latch actuation assembly for opening or closing the seat latch wherein opening the seat latch releases the child safety seat; and an interlock mechanism actuated upon opening the seat latch that prevents rotation of the rotary element with respect to the base. The seat latch actuation assembly may include a slidably mounted handle, wherein in use, the base blocks access to the handle when the seat is in any position other than one or two side-loading position(s).

Another example is disclosed in a U.S. Pat. No. 7,753,444, entitled “Child seat” (“the '444 Patent”). The '444 Patent discloses a child seat attached to a vehicle seat comprises a base platform which is attached on the vehicle seat and comprises a guide groove; and a child seat body which comprises a bottom face and a guided member which is fixed on the bottom face. The guided member being slidably engaged with the guide groove. The guide groove comprises a curved portion. The child seat can turn to a substantially lateral direction to a moving direction of a vehicle by the guided member being guided along the curved portion.

Yet another example is disclosed in a European Publication No. 4,303,071, entitled “Child restraint system” (“the '071 Publication”). The '071 Publication discloses child restraint systems and components of child restraint systems, for example child seats like a toddler seat and an infant seat, support bases of child seats, in particular support bases that are fixable on a vehicle seat and which bases may be an integral part of a child seat or which may be configured such that a child seat is releasably couplable to them.

Although the above discussed disclosures are useful, they still have problems and present incomplete solutions. For example, most of the infant carriers and the child car seats require separate bases for installing them individually in a vehicle. Installing multiple separate bases for different stages of a child's development for using the infant carriers and the child car seats increases costs. Further, installing and uninstalling the infant carriers and the child car seats to different bases increases the hassle for parents. Furthermore, installing multiple separate bases generates waste as products need replacement at different stages of the child's development.

Therefore, there is a need in the art to provide an improved base that can accommodate both an infant carrier and a child car seat.

### SUMMARY OF THE INVENTION

It is an object of the present invention to provide a base that accommodates both an infant carrier and a child car seat.

It is another object of the present invention to provide a single base compatible with both infant carriers, and child car seats in different orientations.

In order to achieve one or more objects, the present subject matter provides a base for accommodating both an infant carrier and a child car seat. The base has a rebound portion and a bottom portion. The bottom portion presents a connection portion. In one embodiment, the bottom portion interfaces with a bottom of the infant carrier such that the infant carrier connects to the base in a rear-facing configuration. In one embodiment, the connection portion includes seat receiving sections that are configured to receive carrier legs of the infant carrier or child car seat legs of the child car seat and enable connection between the base and the infant carrier or a child car seat.

In one advantageous feature of the present subject matter, the base eliminates the need to install multiple bases by offering compatibility for two different child restraint/seating systems i.e., the infant carrier and the child car seat. The infant carrier snaps securely into the base in a rearward-facing orientation, ensuring the safest positioning for newborns and infants. Further, the base accommodates the child car seat capable of both rear-facing and front-facing configurations. This dual functionality of the base allows it to provide protection through all stages of development using a single base. As a result, parents benefit from convenience, and cost savings by avoiding purchase of multiple separate infant carriers, child car seats, and bases.

These and other objects of the present invention will be apparent from review of the following specification and the accompanying drawings.

### BRIEF DESCRIPTION OF THE DRAWINGS

FIG. 1 is an environment in which a base implements, in accordance with one exemplary embodiment of the present subject matter.

FIG. 2A, FIG. 2B and FIG. 2C illustrate a front perspective view, a rear perspective view, and a side view, respectively of the base, in accordance with one embodiment of the present subject matter.

FIG. 3A and FIG. 3B illustrate a side view, and a perspective view, respectively of the base receiving an infant carrier in a rear-facing configuration, in accordance with one embodiment of the present subject matter.

FIG. 4A and FIG. 4B illustrate is a front perspective view, and a rear perspective view, respectively of the infant carrier.

FIG. 5A and FIG. 5B illustrate side views of the base receiving a child car seat in a rear-facing configuration and a front-facing configuration, respectively, in accordance with one embodiment of the present subject matter.

FIG. 6 illustrates a perspective view of child car seat.

### DETAILED DESCRIPTION OF THE PREFERRED EMBODIMENT

The detailed description set forth below in connection with the appended drawings is intended as a description of exemplary embodiments in which the presently disclosed subject matter may be practiced. The term “exemplary” used throughout this description means “serving as an example, instance, or illustration,” and should not necessarily be construed as preferred or advantageous over other embodiments. The detailed description includes specific details for providing a thorough understanding of the presently disclosed base. However, it will be apparent to those skilled in the art that the presently disclosed subject matter may be practiced without these specific details. In some instances, well-known structures and devices are shown in functional or conceptual diagram form in order to avoid obscuring the concepts of the presently disclosed base.

In the present specification, an embodiment showing a singular component should not be considered limiting. Rather, the subject matter preferably encompasses other embodiments including a plurality of the same component, and vice-versa, unless explicitly stated otherwise herein. Moreover, the applicant does not intend for any term in the specification to be ascribed an uncommon or special meaning unless explicitly set forth as such. Further, the present subject matter encompasses present and future known equivalents to the known components referred to herein by way of illustration.

Although the present subject matter describes a base, it is to be further understood that numerous changes may arise in the details of the embodiments of the base. It is contemplated that all such changes and additional embodiments are within the spirit and true scope of this subject matter.

The following detailed description is merely exemplary in nature and is not intended to limit the described embodiments or the application and uses of the described embodiments. As used herein, the word “exemplary” or “illustrative” means “serving as an example, instance, or illustration.” Any implementation described herein as “exemplary” or “illustrative” is not necessarily to be construed as preferred or advantageous over other implementations. All of the implementations described below are exemplary implementations provided to enable persons skilled in the art to make or use the embodiments of the subject matter and are not intended to limit the scope of the subject matter.

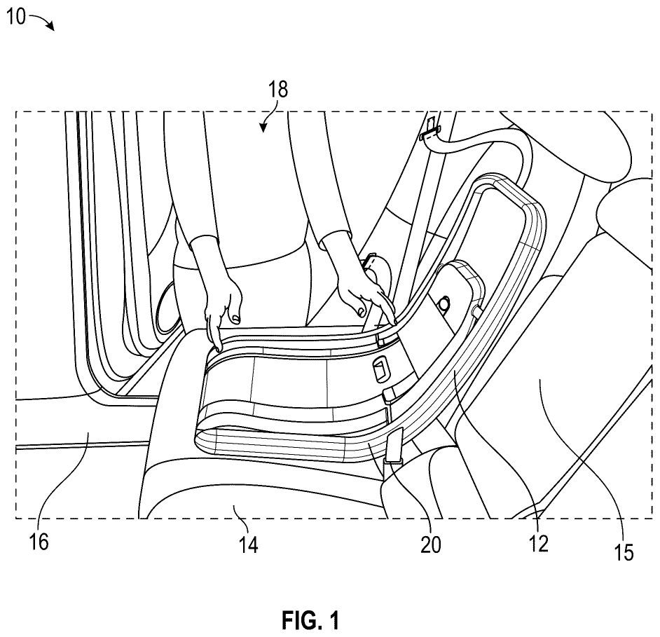

Various features and embodiments of a base are explained in conjunction with the description of FIGS. 1A-6.

FIG. 1 shows an environment 10 in which a base 12 implements, in accordance with one exemplary embodiment of the present subject matter. Base 12 installs on a seat 14 of a vehicle 16, such as a car, for example. A user or parent or caregiver 18 affixes base 12 to seat 14 having contact with a backrest 15 using vehicle seat straps 20.

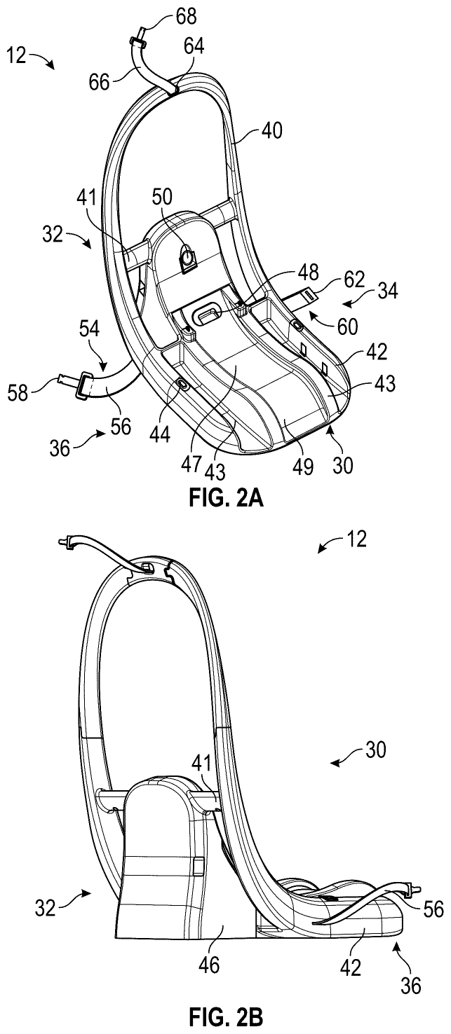

FIG. 2A, FIG. 2B and FIG. 2C show a front perspective view, a rear perspective view, and a side view, respectively of base 12, in accordance with one embodiment of the present subject matter. Base 12 presents a first end 30, a second end 32, a third end 34, and a fourth end 36. First end 30 indicates a front end and second end 32 indicates a rear end, or vice versa of base 12. Third end 34 indicates a left side and fourth end 36 indicates right side, or vice versa of base 12. Base 12 is made of a hard plastic, metal or any other suitable material.

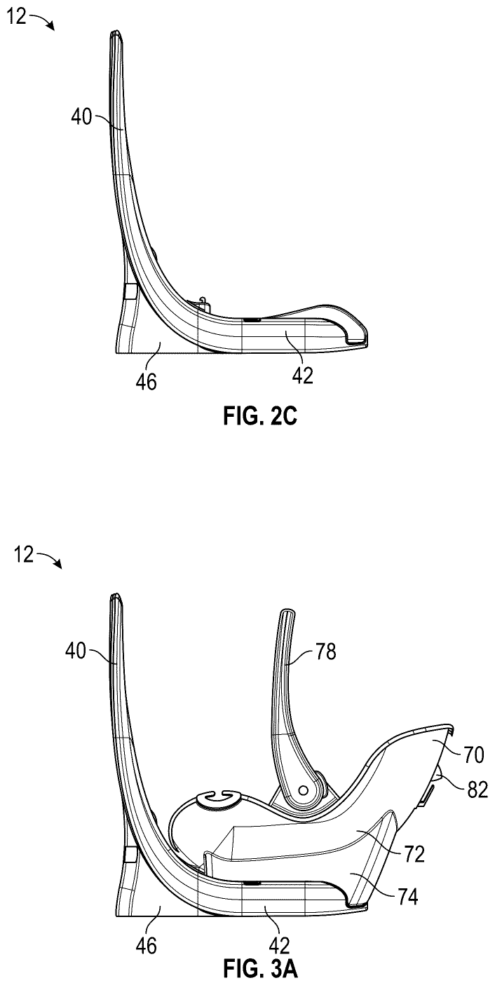

Base 12 encompasses a rebound portion or rebound bar 40. Rebound portion 40 is configured to be in surface contact with backrest 15 of seat 14, as shown in FIG. 1. In one example, rebound portion 40 may also be referred to as an anti-rebound portion or anti-rebound bar, as rebound portion 40 limits the movement against backrest 15. Base 12 includes a bottom portion 42 extending substantially perpendicular from rebound portion 40. Bottom portion 42 is shaped to act as a base member for interchangeably receiving an infant carrier 70 or a child car seat 90. In other words, bottom portion 42 is configured to interface with the bottom of infant carrier 70 or child car seat 90. In one example, bottom portion 42 raises upwardly at the distal end facing first end 30. In one example, bottom portion 42 thickness can be adjusted depending on the height required for placing infant carrier 70 or child car seat 90 over base 12. The adjustment may be indicated by an indicator 44 on both sides of bottom portion 42. Further, base 12 presents a leveling foot 46 at the bottom. Leveling foot 46 positions at the bottom of bottom portion 42. Leveling foot 46 sits at the intersection of seat 14 and backrest 15 and helps to position bottom portion 42 in a flat configuration. In one embodiment, leveling foot 46 is adjustable to conform to the shape of seat 14. Leveling foot 46 defines a L-shaped configuration with a curved portion interfacing with bottom portion 42, as can be seen from at least FIG. 3. In other words, the L-shaped configuration positions over seat 14 and allows to interface curved portion with bottom portion 42.

Base 12 encompasses a connection portion 47. Connection portion 47 may come as a separate component extending from bottom portion 42. Optionally, connection portion 47 may come as an integral component of bottom portion 42. Connection portion 47 extends from first end 30 and substantially till second end 32 of bottom portion 42. In one embodiment, connection portion 47 comes in a flat configuration. In another embodiment, connection portion 47 comes in a curved portion or wave-like pattern to interface with the bottom of infant carrier 70 or child car seat 90. In one exemplary implementation, the distal end of connection portion 47 raises slightly upwards from bottom portion 42. The raised connection portion 47 helps to interface with the bottom of infant carrier 70. In some cases, connection portion 47 connects to rebound bar 40 via a connecting bar 41. Connecting bar 41 acts as a support bar and provides required support for rebound bar 40.

In one embodiment, connection portion 47 presents a seat hole 48. Seat hole 48 indicates a hole provided at connection portion 47 that aligns with a pin/peg/protrusion (not shown) in infant carrier 70 to facilitate a rear-facing configuration for infant carrier 70. Further, connection portion 47 includes an actuator 50. Actuator 50 indicates a lever or button configured to adjust the height of leveling foot 46. In some cases, connection portion 47 includes seat receiving sections 43. Seat receiving sections 43 indicate grooves formed at the sides of connection portion 47 that are configured to receive infant carrier 70 and child car seat 90.

Further, base 12 includes tethers 54 and 60. Tethers 54 and 60 present a first tether 56 extending towards fourth end 36 from rebound portion 40. First tether 56 includes a male latch system 58 at its distal end. Further, tether 60 indicates a second tether extending towards third end 34 from rebound portion 40. Tether 60 includes a female latch system 62 at its distal end. Tethers 54 and 60 are configured to affix to an anchor of seat 14. Further, rebound portion 40 encompasses a latch 64 at the top. Latch 64 helps to affix base 12 to seat 14 in a rear-facing/backward orientation. Further, rebound portion 40 includes a top tether 66. Top tether 66 extends from second end 32 of rebound portion 40. Top tether 66 connects to back of the anchor of seat 14. In one example, top tether 66 includes a tether latch 68 at its distal end.

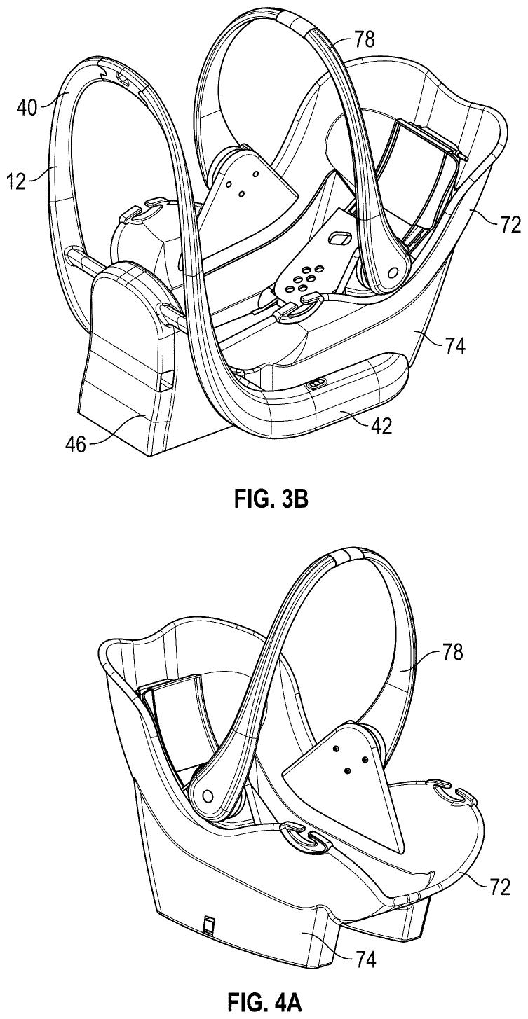

Now referring to FIG. 3A and FIG. 3B, a side view, and a perspective view, respectively, of base 12 receiving infant carrier 70 in a rear-facing configuration is shown, in accordance with one embodiment of the present subject matter. Further, FIG. 4A and FIG. 4B show a front perspective view, and a rear perspective view, respectively of infant carrier 70. As known, infant carrier 70 encompasses a carrier base 72 for receiving an infant. Carrier base 72 has carrier legs 74. Carrier legs 74 extend below from carrier base 72. Here, carrier legs 74 configure to sit within seat receiving sections 43 of base 12 allowing infant carrier 70 to be connected in the rear-facing configuration. In some cases, infant carrier 70 may include a canopy (not shown) to offer protection for the infant. Infant carrier 70 includes a carrier handle 78 for carrying infant carrier 70. Further, infant carrier 70 has a release handle 82 on carrier base 72. Release handle 82 may be operated to disconnect infant carrier 70 from base 12.

In the present subject matter, carrier base 72 is removably connected to connection portion 47 interfacing with seat receiving sections 43 of bottom portion 42, as shown in FIG. 3A and FIG. 3B such that infant carrier 70 positions in a rear-facing configuration. In order to connect carrier base 72 to bottom portion 42, carrier legs 74 insert in seat receiving sections 43 provided at connection portion 47. In one exemplary implementation, release handle 82 is used to release infant carrier 70 from base 12.

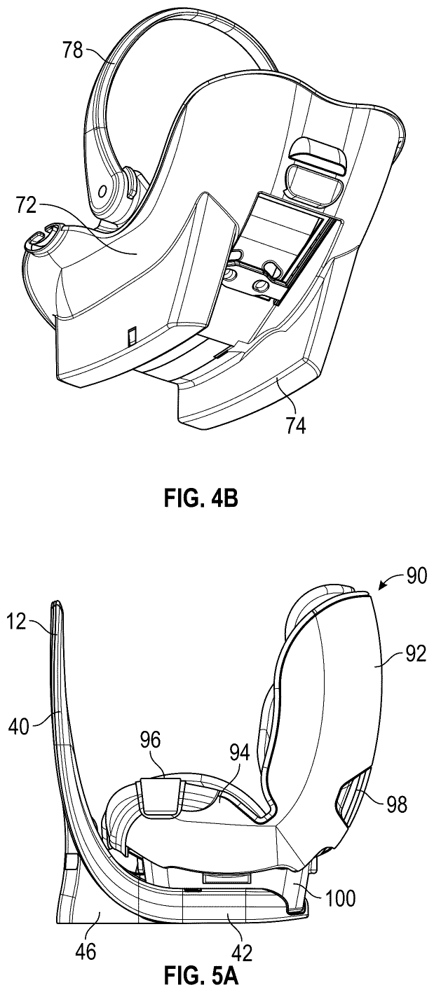

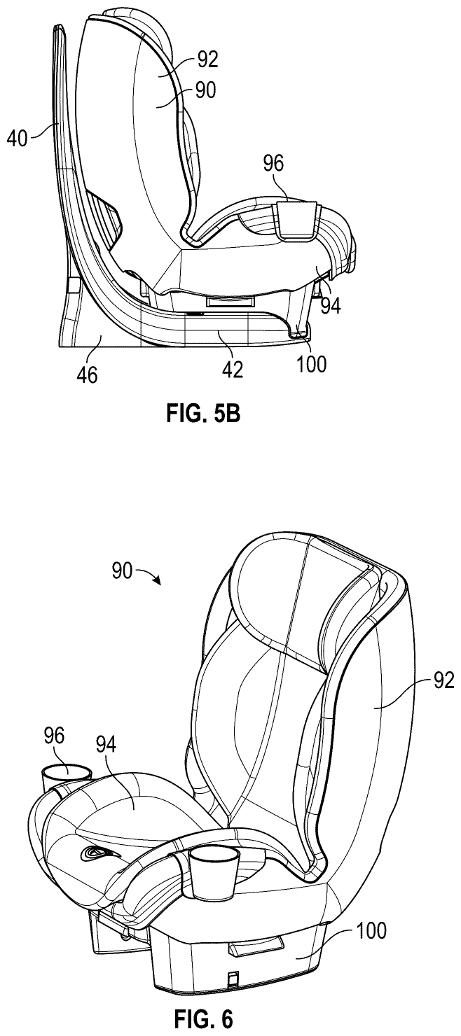

Now referring to FIG. 5A and FIG. 5B, base 12 receiving child car seat 90 in a rear-facing configuration and a front-facing configuration, respectively are shown, in accordance with one embodiment of the present subject matter. Further, FIG. 6 shows a perspective view of child car seat 90. As known, child car seat 90 includes a body portion 92 and a seating portion 94. Body portion 92 and seating portion 94 are made out of a hard plastic or other relatively lightweight and strong material. In one example, body portion 92 and seating portion 94 are covered with a soft cloth or cloth-like material for the comfort of the child sitting in child car seat 90.

In some embodiments, seating portion 94 includes cup receiving portions 96 at both sides. At the sides, body portion 92 defines seat belt paths 98 for receiving the seat belts to connect to seat 14 and/or base 12. Further, child car seat 90 includes child car seat legs 100. Child car seat legs 100 extend below from body portion 92. Here, child car seat legs 100 configure to sit within seat receiving sections 43 of base 12 allowing child car seat 90 to be connected in the rear-facing configuration or the front-facing configuration, depending on the need.

In accordance with the present subject matter, child car seat 90 is mounted to base 12 in a front-facing configuration or rear-facing configuration depending on the need. In order to connect child car seat 90 to base 12 in the front-facing configuration, body portion 92 is made to interface with rebound portion 40, and seating portion 94 is made to interface and connect to bottom portion 42, as shown in FIG. 5B. Here, child car seat legs 100 sit within seat receiving sections 43 of base 12 allowing child car seat 90 to be connected in the front-facing configuration. Optionally, seat belts are drawn through seat belt paths 98 to secure child car seat 90 to seat 14.

In order to connect child car seat 90 in the rear-facing configuration, child car seat 90 is removed from the front-facing configuration. Subsequently, seating portion 94 is made to interface with bottom portion 42 such that body portion 92 is made to face rebound portion 40, as shown in FIG. 5A. Here, child car seat legs 100 sit within seat receiving sections 43 of base 12 allowing child car seat 90 to be connected in the rear-facing configuration.

In accordance with the present subject matter, a single base 12 is used for connecting both infant carrier 70 and child car seat 90. As presented above, infant carrier 70 is connected in a rear-facing configuration to seat an infant. Further, child car seat 90 can be connected in the front-facing configuration or the rear-facing configuration depending on the need. As the single base 12 is sufficient to connect both infant carrier 70 and child car seat 90, there is no need for parents to install multiple bases for two different seating products. Further, base 12 can be used for safeguarding infants and young children for different stages of a child's development during their vehicular travel.

The presently disclosed base provides several advantages over the prior art. The uniquely designed base offers a solution for children's automotive safety needs from birth through early childhood using a single base compatible with both infant carriers and child car seats in multiple configurations. In one example, a car seat system can come with a base, an infant carrier and a child car seat as a multi-component system. In other words, a multi-component system including the base, the infant carrier, and/or the child car seat may come as a package/kit. In such implementation, the base is designed to be compatible with the specifically designed accompanying infant carrier and/or child car seat. The presently disclosed base eliminates the need to install multiple bases by offering compatibility for two different seating products (i.e., the infant carrier and child car seat). The infant carrier snaps securely into the base in a rear-facing configuration, ensuring the safest positioning for newborns and infants. Further, the base accommodates the child car seat capable of both rear-facing and front-facing installations. The base can be fixed to a car seat when the child is an infant (say 0-1 year) and can be removed when the child no longer needs to be seated in the child car seat (say until the age of 2-6 years old).

A person skilled in the art appreciates that the base can come in a variety of shapes and sizes depending on the need and comfort of the user. Further, many changes in the design and placement of components may take place without deviating from the scope of the presently disclosed base.

In the above description, numerous specific details are set forth such as examples of some embodiments, specific components, devices, methods, in order to provide a thorough understanding of embodiments of the present subject matter. It will be apparent to a person of ordinary skill in the art that these specific details need not be employed, and should not be construed to limit the scope of the subject matter.

In the development of any actual implementation, numerous implementation-specific decisions must be made to achieve the developer's specific goals, such as compliance with system-related and business-related constraints. Such a development effort might be complex and time-consuming, but may nevertheless be a routine undertaking of design, fabrication, and manufacture for those of ordinary skill. Hence as various changes could be made in the above constructions without departing from the scope of the subject matter, it is intended that all matter contained in the above description or shown in the accompanying drawings shall be interpreted as illustrative and not in a limiting sense.

The foregoing description of embodiments is provided to enable any person skilled in the art to make and use the subject matter. Various modifications to these embodiments will be readily apparent to those skilled in the art, and the novel principles and subject matter disclosed herein may be applied to other embodiments without the use of the innovative faculty. It is contemplated that additional embodiments are within the spirit and true scope of the disclosed subject matter.

Other embodiments of the invention will be apparent to those skilled in the art from consideration of the specification and practice of the invention disclosed herein. It is intended that the specification and examples be considered as exemplary only, with a true scope and spirit of the invention being indicated by the following claims.

What is claimed is:

1. A base for interchangeably connecting an infant carrier and a child car seat in a vehicle, said base comprising:
a rebound portion configured to be in surface contact with a backrest of a vehicle seat; and
a bottom portion extending substantially perpendicular from said rebound portion,
wherein said bottom portion is configured to selectively engage a bottom of an infant carrier in a rear-facing configuration, and a bottom of a child car seat in either a rear-facing configuration or a front-facing configuration.

2. The base of claim 1, further comprises a connection portion extending from said bottom portion, wherein said connection portion connects to said infant mandating in said rear-facing configuration.

3. The base of claim 2, wherein said connection portion comprises seat receiving sections, and wherein said seat receiving sections receive carrier legs of said infant carrier to enable connection between said base and said infant carrier and.

4. The base of claim 1, further comprises a connection portion extending from said bottom portion, wherein said connection portion comprises seat receiving sections, and wherein said seat receiving sections receive child car seat legs of said child car seat to enable connection between said base and said child car seat.

5. The base of claim 1, further comprises a leveling foot positioned at a bottom of said bottom portion, wherein said leveling foot is positioned at an intersection of said vehicle seat and said backrest.

6. The base of claim 5, wherein said leveling foot is adjustable to conform to a shape of said vehicle seat.

7. The base of claim 1, further comprises a connection portion extending from said bottom portion, wherein said connection portion comprises an actuator configured to adjust a height of said leveling foot.

8. The base of claim 1, wherein said rebound portion comprises tethers having latch systems at distal ends to connect said base to said vehicle seat.

9. The base of claim 1, wherein said child car seat comprises a body portion and a seating portion, and wherein said body portion defines seat belt paths configured to receive seat belts to connect to said vehicle seat and said base.

10. A child seating system, comprising:
a base configured to connect to a vehicle seat of a vehicle using vehicle seat straps, said base comprising:
a rebound portion configured to be in surface contact with a backrest of said vehicle seat; and
a bottom portion extending substantially perpendicular from said rebound portion, wherein said bottom portion interchangeably receives an infant carrier and a child car seat; and
a leveling foot positioned at a bottom of said bottom portion,
wherein said leveling foot conforms to a shape of said vehicle seat and rests at an intersection of said vehicle seat and said backrest, and
wherein said base is configured to selectively engage said infant carrier in a rear-facing configuration, and said child car seat in either a rear-facing configuration or a front-facing configuration.

11. The child seating system of claim 10, further comprises a connection portion extending from said bottom portion, wherein said connection portion connects to said infant mandating in said rear-facing configuration.

12. The child seating system of claim 11, wherein said connection portion comprises seat receiving sections, and wherein said seat receiving sections receive carrier legs of said infant carrier to enable connection between said said base and said infant carrier and.

13. The child seating system of claim 10, further comprises a connection portion extending from said bottom portion, wherein said connection portion comprises seat receiving sections, and wherein said seat receiving sections receive child car seat legs of said child car seat to enable connection between said base and said child car seat.

14. The child seating system of claim 10, further comprises a connection portion extending from said bottom portion, wherein said connection portion comprises an actuator configured to adjust a height of said leveling foot.

15. The child seating system of claim 10, wherein said rebound portion comprises tethers having latch systems at their distal ends to connect said base to said vehicle seat.

16. The child seating system of claim 10, further comprising a latch configured to connect said base to said vehicle seat in said rear-facing configuration.

17. The child seating system of claim 10, wherein said child car seat comprises a body portion and a seating portion, and wherein said body portion defines seat belt paths to receive seat belts to connect to said vehicle seat and said base.

18. A method of providing a base for interchangeably connecting an infant carrier and a child car seat in a vehicle, said method comprising the steps of:
providing a rebound portion, said rebound portion being in surface contact with a backrest of a vehicle seat;
providing a bottom portion extending substantially perpendicular from said rebound portion; and
selectively engaging said bottom portion with a bottom of said infant carrier in a rear-facing configuration and with a bottom of said child car seat in either a rear-facing configuration or a front-facing configuration.

19. The method of claim 18, further comprising:
providing a connection portion extending from said bottom portion for connecting said infant carrier mandating in said rear-facing configuration; and
providing a leveling foot positioned at a bottom of said bottom portion, said leveling foot positioning at an intersection of said vehicle seat and said backrest.

20. The method of claim 18, further comprising providing seat receiving sections at said connection portion for receiving carrier legs of said infant carrier or child car seat legs of said child car seat.
